(19) United States
(12) Patent Application Publication
(10) Pub. No.: US 2005/0170121 A1
(43) Pub. Date: Aug. 4, 2005

(54) Use of a hose based on an irradiation-grafted fluoropolymer for transporting petrol in a service station

(76) Inventors: Anthony Bonnet, Beaumont Le Roger (FR); Fabrice Chopinez, Evreux (FR); Pascal Sebire, Sant-Aubin Le Vertueux (FR); Michael Werth, Bernay (FR); Gregory O'Brien, Downingtown, PA (US); Saeid Zerafati, Villanova, PA (US)

Correspondence Address: Thomas F. Roland, Esq.;Arkema Inc., 2000 Market St., Philadelphia, PA, 19103, US

(21) Appl. No.: 11/000,163

(22) Filed: Nov. 30, 2004

Related U.S. Application Data
(60) Provisional application No. 60/540,488, filed on Jan. 30, 2004.

(30) Foreign Application Priority Data
Dec. 1, 2003 (FR) 03.14062

(51) Int. Cl. F16L 11/00

(52) U.S. Cl. 428/36.91; 138/137

(57) ABSTRACT

The present invention relates to a hose having a layer consisting of a fluoropolymer onto which an unsaturated monomer has been irradiation-grafted and, a polyolefin outer layer. The hose is useful for transporting petrol in a service station. In one embodiment a fluoropolymer, preferably PDVF, layer is placed beside the irradiation-grafted fluoropolymer. The hose may consist of a irradiation-grafted fluoropolymer inner layer and a polyolefin outer layer, or multilayer hose with either a central irradiation-grafted fluoropolymer layer and polyolefin inner and outer layers, or a polyolefin central layer and irradiation-grafted fluoropolymer inner and outer layers. The irradiation-grafted fluoropolymer layer may be replaced with a layer of a blend of a fluoropolymer, preferably PVDF, and of an irradiation-grafted fluoropolymer. It may also be covered with a fluoropolymer.

This application claims benefit, under U.S.C. §119(a) of French National Application Number 03.14062, filed Dec. 1, 2003; and also claims benefit, under U.S.C. §119(e) of U.S. provisional application Ser. No. 60/540,488, filed Jan. 30, 2004.

### FIELD OF THE INVENTION

The present invention relates to a hose based on a fluoropolymer onto which an unsaturated monomer has been irradiation-grafted, used for transporting petrol in a service station. More precisely, this hose comprises at least one layer of a fluoropolymer onto which an unsaturated monomer has been irradiation-grafted and at least one layer of a polyolefin. These hoses are useful for transporting petrol in a service station, in order to convey the fluid from the storage tank to the petrol dispenser and from the petrol dispenser right into the customer's car.

### BACKGROUND OF THE INVENTION

Fluoropolymers, for example those based on vinylidene fluoride CF₂═CH₂ (VDF) such as PVDF (polyvinylidene fluoride) are known to provide excellent mechanical stability properties, very high chemical inertness and good ageing resistance. However, this chemical inertness of fluoropolymers means that it is difficult to bond them or to combine them with other materials.

Patent EP 558 373 discloses a tube for transporting petrol, which comprises, respectively, a polyamide outer layer, a tie layer and an inner layer in contact with the petrol and consisting of a fluoropolymer (advantageously PVDF—the abbreviation for polyvinylidene fluoride). The impermeability to petrol is perfect, but the impact strength is insufficient.

Patents EP 696 301, EP 740 754 and EP 726 926 disclose tubes for transporting petrol, which comprise, respectively, a polyamide outer layer, a tie layer, a PDVF (polyvinylidene fluoride) layer, a tie layer and a polyamide inner layer in contact with the petrol. The impermeability and the impact strength are very good, but, depending on the nature of the polyamide and the coextrusion device used to manufacture this tube, it may be necessary to add a plasticizer to the polyamide inner layer. As a result, this plasticizer may exude and be entrained by the petrol. This may cause blockage of the tube or of the device for injecting the petrol into the engine.

Patent EP 1 243 832 discloses a pipe which comprises a polyamide outer layer, a layer consisting of a blend of a fluoro polymer and an alkyl methacrylate possessing reactive functional groups along its chain and an inner layer consisting of a blend comprising a polyamide matrix and a polyolefin dispersed phase in contact with the petrol.

U.S. Pat. No. 4,749,607 discloses a multilayer system comprising a modified halogenated thermoplastic polymer and a layer of a modified polyolefin. The modified halogenated thermoplastic polymer may be a fluoropolymer into which polar functional groups have been incorporated either by direct copolymerization or by chemical grafting with the aid of a radical initiator.

In the above documents of the prior art, there is no description of a fluoropolymer layer onto which an unsaturated monomer has been irradiation-grafted. In addition, the pipes described usually have an outside diameter of 8 mm and comprise a polyamide layer and they are most particularly useful in motor vehicles in order to convey the petrol from the tank into the device that injects it into the engine. In service stations, larger-diameter hoses are necessary and, if the hoses described in the above prior art are used the cost of these hoses would be too high.

Moreover, it is now known how to produce fluoropolymers onto which an unsaturated monomer has been irradiation-grafted and to make structures in which these modified fluoropolymers form good tie layers between polyleofins and a fluoropolymer. Consequently, a fluoropolymer onto which an unsaturated monomer has been irradiation-grafted will be denoted for simplicity by irradiation-grafted fluoropolymer.

These irradiation-grafted fluoropolymers may also form a layer that adheres to a polyolefin, so that a structure is obtained which has a chemically resistant layer that is also a barrier layer, without the addition of another fluoropolymer layer. The use of such structures for transporting petrol in a service station in order to convey the fluid from the storage tank to the petrol dispenser and from the petrol dispenser into the customer's car has not been disclosed in the prior art.

### SUMMARY OF THE INVENTION

According to a first embodiment, the present invention relates to the use for transporting petrol in a service station in order to convey the fluid from the storage tank to the petrol dispenser and from the petrol dispenser into the customer's car of a hose comprising:
an inner layer in contact with the fluid to be transported, consisting of an irradiation-grafted fluoropolymer and, directly attached to the latter, a polyolefin outer layer.

According to a variant, the irradiation-grafted fluoropolymer layer is replaced with a layer of a blend of afluoropolymer, preferably PVDF, and of an irradiation-grafted fluoropolymer.

According to another variant, the hose comprises a fluoropolymer, preferably PVDF, layer placed beside the irradiation-grafted fluoropolymer. That is to say the hose comprises in succession a fluoropolymer, preferably PVDF, layer, a layer consisting of an irradiation-grafted fluoropolymer (optionally blended with a fluoropolymer) and, directly attached to the latter, a polyolefin outer layer. The irradiation-grafted fluoropolymer is a tie layer between the PVDF layer and the polyolefin layer. The inner layer in contact with the petrol is therefore either an irradiation-grafted fluoropolymer layer or a fluoropolymer (preferably PVDF) layer or a layer of a blend of a fluoropolymer, preferably PVDF, and of an irradiation-grafted fluoropolymer.

According to a second embodiment, the present invention relates to the use for transporting petrol in a service station in order to convey the fluid from the storage tank to the petrol dispenser and from the petrol dispenser into the customer's car of a hose comprising:
a central layer consisting of an irradiation-grafted fluoropolymer and, directly attached to the latter, a polyolefin outer layer and a polyolefin inner layer. The polyolefin inner layer is the layer in contact with the petrol.

According to one variant, the irradiation-grafted fluoropolymer layer is replaced with a layer of a blend of a fluoropolymer, preferably PVDF, and of an irradiation-grafted fluoropolymer.

According to a third embodiment, the present invention relates to the use for transporting petrol in a service station in order to convey the fluid from the storage tank to the petrol dispenser and from the petrol dispenser into the customer's car of a hose comprising:
a central layer consisting of a polyolefin and, directly attached to the latter, an irradiation-grafted fluoropolymer outer layer and an irradiation-grafted fluoropolymer inner layer.

According to one variant, at least one of the irradiation-grafted fluoropolymer layers is replaced with a layer of a blend of a fluoropolymer, preferably PVDF, and of an irradiation-grafted fluoropolymer.

According to another variant, at least one of the irradiation-grafted fluoropolymer layers (optionally blended with a fluoropolymer) is covered with a fluoropolymer, preferably PVDF, layer. The irradiation-grafted fluoropolymer layer is a tie layer between the PVDF layer and the polyolefin layer. The inner layer in contact with the petrol is therefore either a fluoropolymer -(preferably PVDF) layer or an irradiation-grafted fluoropolymer layer or a layer of a blend of a fluoropolymer, preferably PVDF, and of an irradiation-grafted fluoropolymer.

In the above hoses, it is possible to place, between the irradiation-grafted fluoropolymer layer (or the layer containing the irradiation-grafted fluoropolymer) and the polyolefin layer (or layers), a functionalized polyolefin layer having functional groups capable of reacting with functional groups irradiation-grafted onto the fluoropolymer. For example, if maleic anhydride has been irradiation-grafted onto the fluoropolymer, the functionalized polyolefin layer consists of a copolymer of ethylene, glycidyl methacrylate and optionally an alkyl acrylate, optionally as a blend with polyethylene.

In the above structures, the inner layer in contact with the fluid to be transported may contain carbon black, carbon nanotubes or any other additive capable of making the said layer conductive in order to prevent the accumulation of static electricity.

These hoses may be manufactured by coextrusion—this technique is known per se.

The invention also relates to the hoses used in the third embodiment as novel articles.

### DETAILED DESCRIPTION OF THE INVENTION

As regards the fluoropolymer, this denotes any polymer having in its chain at least one monomer chosen from compounds that contain a vinyl group capable of opening in order to be polymerized and that contains, directly attached to this vinyl group, at least one fluorine atom, a fluoroalkyl group or a fluoroalkoxy group.

As examples of monomers, mention may be made of vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is 1, 2, 3 or 4; the product of formula R₃OCF═CH₂ in which R₃ is F(CF₂)_{z}- and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also include non-fluorinated monomers such as ethylene.

As examples, the fluoropolymer is chosen from:
homopolymers and copolymers of vinylidene fluoride (VDF) preferably containing, by weight, at least 50% VDF, the copolymer being chosen from chlorotrifluoroethylene (CTFE), hexafluoropropylene (HFP), trifluoroethylene (VF3) and tetrafluoroethylene (TFE);
homopolymers and copolymers of trifluoroethylene (VF3); and
copolymers, and especially terpolymers, combining the residues of chlorotrifluoroethylene (CTFE), tetrafluoroethylene (TFE), hexafluoropropylene (HFP) and/or ethylene units and optionally VDF and/or VF3 units.

Advantageously, the fluoropolymer is a poly(vinylidene fluoride) (PVDF) homopolymer or copolymer. Preferably, the PVDF contains, by weight, at least 50%, or preferably at least 75% and better still at least 85% VDF. The comonomer is advantageously HFP.

Advantageously, the PVDF has a viscosity ranging from 100 Pa.s to 2000 Pa.s, the viscosity being measured at 230° C. and a shear rate of 100 s⁻¹ using a capillary rheometer. These PVDFs are well suited to extrusion and to injection moulding. Preferably, the PVDF has a viscosity ranging from 300 Pa.s to 1200 Pa.s, the viscosity being measured at 230° C. with a shear rate of 100 s⁻¹ using a capillary rheometer.

Thus, PVDFs sold under the brand name KYNAR® 710 or 720 are perfectly suitable for this formulation.

With regard to the irradiation-grafted fluoropolymer, this is obtained by an irradiation. grafting process in which an unsaturated monomer is grafted onto a fluoropolymer.

The fluoropolymer is preblended with the unsaturated monomer by any melt-blending techniques known in the prior art. The blending step is carried out in any blending device such as extruders or mixers used in the thermoplastics industry. Preferably, an extruder will be used to make the blend in the form of granules.

The fluoropolymer/unsaturated monomer blend is then irradiated in the solid state using an electron or photon source with an irradiation dose of between 10 and 200 kGray, preferably between 10 and 150 kGray. Irradiation by means of a cobalt 60 bomb is particularly preferred.

This results in the unsaturated monomer being grafted to an amount of 0.1 to 5 wt % (that is to say the grafted unsaturated monomer corresponds to 0.1 to 5 parts per 99.9 to 95 parts of fluoropolymer), advantageously 0.5 to 5 wt % and preferably 1 to 5 wt %. The grafted unsaturated monomer content depends on the initial content of the unsaturated monomer in the fluoropolymer/unsaturated monomer blend to be irradiated. It also depends on the grafting efficiency, and therefore on the duration and the energy of the irradiation.

The unsaturated monomer that has not been grafted and the residues liberated by the grafting, especially the HF, are then removed. This operation may be carried out using techniques known to those skilled in the art. Vacuum degassing may be applied, optionally heating at the same time. It is also possible to dissolve the modified fluoropolymer in a suitable solvent, such as for example N-methyl pyrrolidone, and then to precipitate the polymer in a non-solvent, for example in water or in an alcohol.

One of the advantages of this irradiation grafting process is that it is possible to obtain higher grafted unsaturated monomer contents than with conventional grafting processes using a radical initiator. Thus, typically, with the irradiation grafting process, it is possible to obtain contents of greater than 1% (one part of unsaturated monomer per 99 parts of fluoropolymer), or even greater than 1.5%, whereas with a conventional grafting process carried out in an extruder, the content is around 0.1 to 0.4%.

Moreover, the irradiation grafting takes place “cold”, typically at temperatures below 100° C., or even below 70° C., so that the fluoropolymer/unsaturated monomer blend is not in the melt state, as in the case of a conventional grafting process carried out in an extruder. One essential difference is therefore that, in the case of a semicrystalline fluoropolymer (as is the case with PVDF for example) the grafting takes place in the amorphous phase and not in the crystalline phase, whereas homogeneous grafting is produced in the case of grafting in the melt state carried out in an extruder. The unsaturated monomer is therefore not distributed among the fluoropolymer chains in the same way in the case of irradiation grafting as in the case of grafting carried out in an extruder. The modified fluoropolymer therefore has a different distribution of the unsaturated monomer among the fluoropolymer chains compared with a product obtained by grafting carried out in an extruder.

During this grafting step, it is preferable to prevent oxygen from being present. It is therefore possible to remove the oxygen by flushing the fluoropolymer/ unsaturated monomer blend with nitrogen or argon.

The grafted fluoropolymer thus obtained may be used as such or in a blend, either with the same fluoropolymer, but not irradiation-grafted, or with another fluoropolymer, or with another polymer such as, for example, an acrylic polymer. As examples of acrylic polymer, mention may be made of PMMA and impact modifiers of the core/shell type.

The irradiation-grafted fluoropolymer has all the characteristics of the fluoropolymer before modification, especially its very good chemical resistance and its very good oxidation resistance, and also its thermomechanical behaviour. In addition, the polymers modified according to the process of the present invention have greatly improved adhesion properties compared with the unmodified fluoropolymers.

With regard to the unsaturated monomer, this possesses at least one double bond C═C, and at least one polar functional group that may be one of the following functional groups:
a carboxylic acid;
a carboxylic acid salt;
a carboxylic acid anhydride;
an epoxide;
a carboxylic acid ester;
a silyl;
a carboxylic amide;
a hydroxyl;
an isocyanate.

It is also possible to envisage using mixtures of several unsaturated monomers. Unsaturated dicarboxylic acids having 4 to 10 carbon atoms and their functional derivatives, particularly their anhydrides, are particularly preferred grafting monomers.

We may mention as examples of unsaturated monomers, methacrylic acid, acrylic acid, fumaric acid, itaconic acid, undecylenic acid, zinc, calcium or sodium undecylenate, maleic anhydride, dichloromaleic anhydride, difluoromaleic anhydride, itaconic anhydride, crotonic anhydride, glycidyl acrylate, glycidyl methacrylate, allyl glycidyl ether, vinylsilanes, such as vinyltrimethoxysilane, vinyltriethoxysilane, vinyltriacetoxysilane and γ-methacryloxypropyltrimethoxysilane.

Preferably, to achieve good adhesion, maleic anhydride or zinc, calcium or sodium undecylenates will be chosen. These unsaturated monomers also have the advantage of being solid, which makes it easier to introduce them into an extruder. Maleic anhydride is most particularly preferred as it makes it possible to achieve good adhesion properties.

Other grafting monomers that can be used are, for example, C₁-C₈ alkyl esters or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; amide derivatives of unsaturated carboxylic acids, such as acrylamide, methacrylamide, the monoamide of maleic acid, the diamide of maleic acid, the N-monoethylamide of maleic acid, the N,N-diethylamide of maleic acid, the N-monobutylamide of maleic acid, the N,N-dibutylamide of maleic acid, the monoamide of fumaric acid, the diamide of fumaric acid the N-monoethylamide of fumaric acid, the N,N-diethylamide of fumaric acid, the N-monobutylamide of fumaric acid and the N,N-dibutylamide of fumaric acid; imide derivatives of unsaturated carboxylic acids, such as maleimide, N-butylmaleimide and N-phenylmaleimide; and metal salts of unsaturated carboxylic acids, such as sodium acrylate, sodium methacrylate, potassium acrylate and potassium methacrylate.

Because of the presence of a C═C double bond in the unsaturated monomer, polymerization of the unsaturated monomer, to give polymer chains either grafted onto the fluoropolymer, or free chains, that is to say those not attached to the fluoropolymer, is not excluded. The term “polymer chain” is understood to mean a chain-linking of more than ten unsaturated monomer units. Within the context of the invention, to promote the adhesion properties of the fluoropolymer, it is preferable to limit the presence of grafted or free polymer chains, and therefore to seek to obtain chains with fewer than ten unsaturated monomer units. Chains limited to fewer than five unsaturated monomer units will be preferred, and those having fewer than two unsaturated monomer units will be even more preferred.

Likewise, it is not excluded for there to be more than one C═C double bond in the unsaturated monomer. Thus, for example, unsaturated monomers such as allyl methacrylate, trimethylolpropane trimethacrylate or ethylene glycol dimethacrylate may be used. However, the presence of more than one double bond in these compounds may result in crosslinking of the fluoropolymer, and therefore in a modification in the rheological properties, or even in the presence of gels, which is not desirable. It may then be difficult to obtain a high grafting efficiency, while still limiting crosslinking. Unsaturated monomers containing only a single C═C double bond are also preferred. The preferred unsaturated monomers are therefore those possessing a single C═C double bond and at least one polar functional group.

From this standpoint, maleic anhydride and also undecylenic acid and zinc, calcium or sodium undecylenates constitute good graftable compounds as they have little tendency to polymerize or even to give rise to crosslinking. Maleic anhydride is most particularly preferred.

With regard to the proportions of the fluoropolymer and of the unsaturated monomer, the proportion of fluoropolymer is advantageously, by weight, from 90 to 99.9% per 0.1 to 10% of unsaturated monomer, respectively. Preferably, the proportion of fluoropolymer is from 95 to 99.9% per 0.1 to 5% of unsaturated monomer, respectively.

After the blending step, it is found that the blend of the fluoropolymer and the unsaturated monomer has lost about 10 to 50% of the unsaturated monomer that had been introduced at the start of the blending step. This proportion depends on the volatility and the nature of the unsaturated monomer. In fact, the monomer was vented in the extruder or the blender and it was recovered from the venting circuits.

As regards the grafting step proper, the products recovered after step b) are advantageously packaged in polyethylene bags, the air is expelled and the bags then sealed. As regards the method of irradiation, it is possible to use, without distinction, electron irradiation, more commonly known as β irradiation, and photon irradiation, more commonly known as γ irradiation. Advantageously, the dose is between 2 and 6 Mrad and preferably between 3 and 5 Mrad.

With regard to the step of removing the non-grafted unsaturated monomer and the residues liberated by the grafting, it is possible to use any technique known to those skilled in the art. The proportion of irradiation-grafted monomer relative to the amount of monomer present at the start of the blending step is between 50 and 100%. The product may be washed with solvents that are inert to the fluoropolymer and to the irradiation-grafted functional groups. For example, when grafting with maleic anhydride, the product may be washed with chlorobenzene. It is also possible, more simply, to vacuum-degas the product recovered at the end of the grafting step, optionally by heating.

The hoses used in the three embodiments will now be described. These hoses may be of any size—advantageously, the outside diameter is between 10 and 100 mm and the thickness between 1 and 5 mm. The fluoropolymer that may be blended with the irradiation-grafted fluoropolymer is advantageously PVDF homopolymer or copolymer. The proportions by weight may be from 1 to 90% of PVDF and preferably from 20 to 60%. The fluoropolymer layer that may be added against the irradiation-grafted fluoropolymer layer in the first and third embodiments is advantageously of PVDF homopolymer or copolymer. The polyolefin layer may be made of polyethylene or polypropylene. Advantageously, this is HDPE. For example, mention may be made of FINATHENE 3802 from Arkema; it has a density of 0.938 and an MVI (Melt volume Index) of 0.2 cm³/10 min (190° C./2.16 kg). As regards the functional polyolefin layer that may be inserted between the irradiation-grafted fluoropolymer layer and the polyolefin layer, this is advantageously a polyolefin containing an epoxide, since the irradiation-grafted fluoropolymer is advantageously grafted with an anhydride.

This functional polyolefin is either an ethylene/unsaturated epoxide copolymer or a polyolefin grafted with an unsaturated epoxide.

With regard to the polyolefin grafted with an unsaturated epoxide, the term “polyolefin” is understood to mean polymers comprising olefin units such as, for example, ethylene, propylene, 1-butene units, or any other α-olefin. As example, mention may be made of:
polyethylenes, such as LDPE, HDPE, LLDPE or VLDPE, polypropylene, ethylene/propylene copolymers, EPRs (ethylene/propylene rubbers) or else metallocene PEs (copolymers obtained by monosite catalysis);
copolymers of ethylene with at least one product chosen from salts or esters of unsaturated carboxylic acids, or vinyl esters of saturated carboxylic acids. The polymers in question may also be styrene/ethylene-butylene/styrene (SEBS) block copolymers, styrene/butadiene/styrene (SBS) block copolymers, styrene/isoprene/styrene (SIS) block copolymers, styrene/ ethylene-propylene/styrene block copolymers and ethylene/propylene/diene (EPDM) copolymers.

Advantageously, the polyolefin is chosen from LLDPE, VLDPE, polypropylene, ethylene/vinyl acetate copolymers or ethylene/alkyl (meth)acrylate copolymers. Advantageously, the density may be between 0.86 and 0.965 and the melt flow index (MFI) may be between 0.3 and 40 (g/10 min at 190° C./2.16 kg).

With regard to ethylene/unsaturated epoxide copolymers, mention may be made, for example, of copolymers of ethylene with an alkyl (meth)acrylate and an unsaturated epoxide or copolymers of ethylene with a vinyl ester of a saturated carboxylic acid and with an unsaturated epoxide. The amount of epoxide may be up to 15% by weight of the copolymer and the amount of ethylene at least 50% by weight. Advantageously, the proportion of epoxide is between 2 and 10% by weight. Advantageously, the proportion of alkyl (meth)acrylate is between 0 and 40% by weight and preferably between 5 and 35% by weight.

Advantageously, this is an ethylene/alkyl (meth)acrylate/unsaturated epoxide copolymer.

Preferably, the alkyl (meth)acrylate is such that the alkyl possesses 2 to 10 carbon atoms.

The MFI (melt flow index) may, for example, be between 0.1 and 50 (g/10 min at 190° C./2.16 kg).

Examples of alkyl acrylates or alkyl methacrylates that can be used are especially methyl methacrylate, ethyl acrylate, n-butyl acrylate, isobutyl acrylate and 2-ethylhexyl acrylate. Examples of unsaturated epoxides that can be used are especially:
aliphatic glycidyl esters and ethers such as allyl glycidyl ether, vinyl glycidyl ether, glycidyl maleate, glycidyl itaconate, glycidyl acrylate and glycidyl methacrylate; and
alicyclic glycidyl esters and ethers such as 2-cyclohexen-1-yl glycidyl ether, diglycidyl cyclohexene-4,5-carboxylate, glycidyl cyclohexene-4-carboxylate, glycidyl 2-methyl-5-norbornene-2-carboxylate and diglycidyl endo-cis-bicyclo[2.2.1]-hept-5-ene-2,3-dicarboxylate.

### EXAMPLES

The following fluoropolymers were used:
KYNAR 720: a PVDF homopolymer from Arkema having an MVI (Melt Volume Index) of 10 cm³/10 min (230° C./5 kg);
KYNAR ADX 120: a PVDF homopolymer irradiation-grafted with maleic anhydride (containing 0.6% anhydride) and sold by Arkema, having an MVI (Melt Volume Index) of 7 cm³/10 min (230° C./5 kg).
   Preparation of ADX 120

A blend of KYNAR 720 PVDF (from Arkema) and of 1.2 wt % maleic anhydride was prepared. This blend was prepared using a twin-screw extruder operating at 230° C. and 150 rpm with a throughput of 10 kg/h. The granulated product thus prepared was bagged, in aluminium-lined sealed bags and then oxygen was removed by flushing with a stream of agon. These bags were then irradiated by γ irradiation (Co⁶⁰ bomb) at 3 Mrad (10 MeV acceleration). for 17 hours. A 50% grafting level was determined, this level being checked after a step of dissolving the material in N-methylpyrrolidone and then precipitation in a water/THF mixture (50/50 by weight). The product obtained after the grafting operation was then placed under vacuum overnight at 130° C. in order to remove the residual maleic anhydride and the hydrofluoric acid liberated during the irradiation. The final grafted maleic anhydride content was 0.6% (infrared spectroscopic analysis of the C═O band at around 1870 cm⁻¹).

The following functional polyolefin was used:
LOTADER 8840: an ethylene/glycidyl methacrylate copolymer from Arkema, having an MVI (Melt Volume Index) of 5 cm³/10 min (190° C./2.16 kg). It contains 92% ethylene and 8% glycidyl methacrylate by weight.

The following polyethylene was used:
HDPE 2040ML55: this denotes a high-density polyethylene from Arkema, having an MFI of 4 g/10 min at 2.16 kg/190° C. Its density is 0.955.

### Example 1

### According to the Invention

A three-layer structure was coextruded on a McNeill coextrusion line, the said structure consisting, from the outside inwards, of HPDE 2040ML55 (2.6 mm) coextruded over a LOTADER 8840 layer (100 μm) and a KYNAR ADX 120 layer (300 μm). The tube obtained, with a diameter of 32 mm and a thickness of 3 mm, had a non-peelable interface between the LOTADER and the HDPE and an adhesive strength of 60 N/cm between the LOTADER and the KYNAR ADX 120. No coextrusion problem was posed by this three-layer structure. After ageing in M15 petrol at 60° C. for 1 month, no loss of cohesion was observed and a peel force of 25 N/cm was measured.

### Example 2

### Comparative Example

A three-layer structure was coextruded on a McNeill coextrusion line, the said structure consisting, from the outside inwards, of HDPE 2040ML55 (2.6 mm) coextruded over a LOTADER 8840 layer (100 μm) and a KYNAR 720 layer (300 μm). The tube obtained, having a diameter of 32 mm and a thickness of 3 mm, had a non-peelable interface between the LOTADER and the HDPE and an adhesive strength of 1 N/cm between the LOTADER and the KYNAR 720. No extrusion problem was posed by this three-layer structure. After storage at room temperature for 30 minutes, spontaneous delamination occurred between the PDVF and the LOTADER.

### Example 3

### According to the Invention

A four-layer structure was coextruded on a McNeill coextrusion line, the said structure consisting, from the outside inwards, of HDPE 2040ML55 (2.6 mm) coextruded over a LOTADER 8840 layer (100 μm) and a KYNAR ADX 120 layer (100 μm) and a KYNAR 720 layer (200 μm). The tube obtained, having a diameter of 32 mm and a thickness of 3 mm, had a non-peelable interface between the LOTADER and the HDPE, an adhesive strength of 60 N/cm between the LOTADER and the KYNAR ADX 120 and a non-peelable interface between the KYNAR ADX 120 and the KYNAR 720. No coextrusion problem was posed by this four-layer structure. After ageing in M15 petrol at 60° C. for one month, no loss of cohesion was observed and a peel force of 25 N/cm was measured at the LOT-ADER/KYNAR ADX 120 interface.

### Example 4

### According to the Invention

A five-layer structure was coextruded on a McNeill coextrusion line, the said structure consisting, from the outside inwards, of KYNAR ADX 120 (200 μm), LOTADER 8840 (100 μm), HDPE 2040ML55 (2.4 mm) coextruded over a LOTADER 8840 layer (100 μm) and a KYNAR ADX 120 layer (200 μm). The tube obtained, having a diameter of 32 mm and a thickness of 3 mm, had a non-peelable interface between the LOTADER and the HPDE, an adhesive strength of 40 N/cm between the LOTADER and the external KYNAR ADX 120 and a peel force of 55 N/cm between the LOTADER and the internal KYNAR ADX 120. No coextrusion problem was posed by this five-layer structure. After ageing in M15 petrol at 60° C. for one month, no loss of cohesion was observed and a peel force of 15 N/cm was measured at the LOTADER/external KYNAR ADX 120 interface and an adhesive strength of 24 N/cm was measured at the LOTADER/internal KYNAR ADX 120 interface.

### Example 5

### According to the Invention

A three-layer structure was coextruded on a McNeill coextrusion line, the said structure consisting, from the outside inwards, of KYNAR ADX 120 (150 μm), a STAMYLEX 1016 LF (LLDPE having an MFI of 1.1 g/10 min at 190° C./2.16 kg) PE/LOTADER 8840 blend in proportions of 50/50 by weight (2.7 mm in thickness) and a further KYNAR ADX 120 layer (150 μm). The tube obtained, having a diameter of 32 mm and a thickness of 3 mm, had an adhesive strength of 35 N/cm between the external KYNAR ADX 120 and the PE/LOTADER blend and an adhesive strength of 45 N/cm between the internal KYNAR ADX 120 and the PE/LOTADER blend. No coextrusion problem was posed by this three-layer structure. Ageing in M15 petrol at 60° C. showed that there was no observed loss of cohesion. This structure had a petrol uptake of less than 1% after one month.

1. A hose having at least an inner and an outer layer comprising a layer consisting of a polyolefin and a layer consisting of a fluoropolymer onto which an unsaturated monomer has been irradiation-grafted.

2. The hose according to claim 1 wherein said polyolefin layer is directly attached to said irradiation-grafted fluoropolymer.

3. The hose of claim 2 wherein said inner layer consists of said fluoropolymer onto which an unsaturated monomer has been irradiation-grafted, and said outer-layer consists of said polyolefin.

4. The hose according to claim I wherein a layer of a functionalized polyolefin having functional groups capable of reacting with the functional groups irradiation-grafted onto the fluoropolymer is placed between the irradiation-grafted fluoropolymer layer and the polyolefin layer.

5. The hose according to claim 4, in which the functional polyolefin is either an ethylene/unsaturated epoxide copolymer or a polyolefin grafted with an unsaturated epoxide.

6. The hose according to claim 1 comprising a central layer consisting of a polyolefin and an irradiation-grafted fluoropolymer outer layer and an irradiation-grafted fluoropolymer inner layer.

7. The hose according to claim 1, wherein at least one irradiation-grafted fluoropolymer layer is replaced with a layer of a blend of a fluoropolymer and of an irradiation-grafted fluoropolymer.

8. The hose according to claim 1, in which at least one irradiation-grafted fluoropolymer layer is covered with a fluoropolymer layer.

9. The hose according to claim 1 comprising a central layer consisting of an irradiation-grafted fluoropolymer inner layer and an irradiation-grafted fluoropolymer inner layer.

10. The hose according to claim 1 wherein said irradiation-grafted fluoropolymer layer is replaced with a layer consisting of a blend of a fluoropolymer and an irradiation-grafted fluoropolymer.

11. The hose according to claim 9 wherein said fluoropolymer comprises polyvinylidene fluoride.

12. The hose according to claim 1 further comprising a fluoropolymer layer attached directed to the irradiation-grafted fluoropolymer.

13. The hose according to claim 1 comprising a central layer consisting of an irradiation-grafted fluoropolymer and, directly attached thereto, a polyolefin outer layer and a polyolefin inner layer.

14. The hose according to claim 1, in which the unsaturated monomer possesses at least one C═C double bond and at least one polar functional group selected from the group consisting of a carboxylic acid, carboxylic acid salt, carboxylic acid anhydride, epoxide, carboxylic acid ester, silyl; carboxylic amide, hydroxyl, and isocyanate functional group.

15. The hose according to claim 14, in which the unsaturated monomer possesses only a single C═C double bond.

16. The hose according to claim 14, in which the unsaturated monomer is an unsaturated carboxylic acid anhydride.

17. The hose according to claim 16, in which the unsaturated monomer is maleic anhydride.

18. The hose according to claim 14, in which the unsaturated monomer is undecylenic acid or zinc, calcium or sodium undecylenates.

19. The hose according to claim 1, in which the inner layer is in contact with a fluid to be transported and further comprises carbon black, carbon nanotubes or any other additive capable of making it conductive in order to prevent the accumulation of static electricity.

20. A process for transporting petrol in a service station in order to convey the fluid from the storage tank to the petrol dispenser and from the petrol dispenser into the customer's car of a hose comprising using a hose having at least an inner and an outer layer comprising a layer consisting of a polyolefin and a layer consisting of a fluoropolymer onto which an unsaturated monomer has been irradiation-grafted.
